(19) United States
(12) Patent Application Publication
(10) Pub. No.: US 2020/0023745 A1
(43) Pub. Date: Jan. 23, 2020

(54) NON-CONTACT RADIAL SYNCHRONIZATION

(71) Applicant: Hyperloop Technologies, Inc., Los Angeles, CA (US)

(72) Inventor: Kornel NIEDZIELA, Los Angeles, CA (US)

(73) Assignee: Hyperloop Technologies, Inc., Los Angeles, CA (US)

(21) Appl. No.: 16/179,382

(22) Filed: Nov. 2, 2018

Related U.S. Application Data
(60) Provisional application No. 62/582,033, filed on Nov. 6, 2017.

(51) Int. Cl. B60L 13/04; B60B 17/00; B61B 13/08

(52) U.S. Cl. CPC B60L 13/04; B61B 13/08; B60B 17/00

(57) ABSTRACT

A wheel, a magnet-wheel system and a method including a wheel for a transport vehicle movable along a guideway in a transportation system. The transportation system includes a conductive surface arranged substantially parallel to the guideway. The wheel includes at least one magnet is affixed to at least one of an exterior of the wheel or an interior of the wheel. The wheel is rotatably drivable by drag forces created in the conductive surface, which is spatially separate from the wheel in transport.

### CROSS-REFERENCE TO RELATED APPLICATION

The present application claims the benefit of U.S. Provisional Application 62/582,033 filed Nov. 6, 2017, the disclosure of which is expressly incorporated by reference herein in its entirety.

### BACKGROUND OF THE EMBODIMENT

### 1. Field of the Disclosure

The present disclosure relates to landing wheels, namely a method in which to passively synchronize the velocity between a rotating object and a conductive surface in a magnetic-levitation transport system.

### 2. General Background Information

Vehicular transportation transitioning from an airborne state to a grounded state typically requires a touchdown event, at which the vehicle makes contact with the ground. At the moment of contact with the ground, the vehicle must be able to maintain forward momentum without causing excessive vibration from the touchdown event. In this way, integrity of the vehicle can be best preserved. This is typically accomplished through external supports that allow for smooth transition from airborne movement to grounded movement that also easily carries momentum forwards on the ground. Such supports can include, for example, skids or wheels, as these structures are able to withstand the dynamic loading from touchdown, as well as translate the horizontal motion into sliding or rolling movement, respectively, without breaking down.

The amount of force a support undergoes upon a touchdown event is dependent on the load applied to it. Those of ordinary skill know that at touchdown, dynamic load on a wheel can be reduced if the wheel is already rolling, which significantly lessens the acceleration component of force. In contrast, for a stationary wheel, because the wheel must quickly accelerate in rotation to match the speed of the surface underneath to properly carry horizontal motion forwards, there is a great amount of force applied to the wheel in addition to the force of the vehicle landing on the surface. As the speed of the vehicle increases, the dynamic load at the touchdown event increases; thus, a vehicle moving at higher speed will have a much greater dynamic load on its stationary wheels than a vehicle at a lower speed. Eventually these forces can cause destructive or irreparable damage to a wheel should they exceed the threshold of a wheel's tolerance and can lead to fatigue, stress, or even tire blowout, and other modes of failure

Thus, there is a need in the art for an improved apparatus and method to synchronize the velocity between a rotating object and a conductive surface in a magnetic-levitation transport system.

### BRIEF SUMMARY

As commonly seen in airplanes, wheels used for touchdown should be sturdy enough to withstand the force of impact with the landing surface. An object subjected to rapid acceleration will experience greater amounts of force. Thus, a wheel that is not rotating prior to impact with the landing surface, will experience a greater amount of force that is dependent on the speed to which the wheel must accelerate to in order to roll along a surface. This dynamic loading can lead to fatigue, stress, or even tire blowout (and other modes of failure). One method of circumventing these dynamic loading drawbacks is to make wheels sturdier and thereby better able to withstand greater loads. However, making sturdier wheels does not prevent wear and tear over time, it merely gives the wheels a greater tolerance prior to breaking. Another method of resolving or alleviating the problem of dynamic loading is the active rotation of wheels prior to touchdown, through some driving force, such as by air current or motor. However, this requires being able to determine the speed at which the vehicle is moving, and requires a driving force, dependent on having power to actuate the wheels.

Embodiments of the present disclosure may be used in a transportation system, for example, as described in commonly-assigned application Ser. No. 15/007,783, titled “Transportation System,” the contents of which are hereby expressly incorporated by reference herein in their entirety.

In the emergent field of magnetic-levitation transportation, touchdown is prevalent when coming to a stop, or as a fail-safe in the event of power-loss. Magnetic-levitation in a low-pressure environment allows a vehicle to overcome the obstacles of friction, and achieve greater speeds. However, the speeds at which a vehicle may be moving makes implementing sturdier wheels impractical, and wheels that could withstand dynamic loading at the speeds obtainable would add significant amounts of additional weight. Implementing active methods of rotational synchronization of the wheels introduces additional drag through the addition of more equipment to measure speed and translate to rotational force. Furthermore, a prevalent concern of failure with magnetic levitation comes from power-loss, due to the nature of lift being generated solely through electrical power; active methods of radial synchronization fail in the face of loss of power, and as such, do not provide an appropriate solution to reducing the dynamic loads placed upon wheels during touchdown.

Embodiments are directed to a wheel for a transport vehicle movable along a guideway in a transportation system, in which the transportation system includes a conductive surface arranged substantially parallel to the guideway. The wheel includes at least one magnet affixed to at least one of an exterior of the wheel or an interior of the wheel. The wheel is rotatably drivable by drag forces created in the conductive surface, which is spatially separate from the wheel in transport.

According to embodiments, the wheel can further include a wheel running surface defining an outer periphery, and the at least one magnet is affixed to an interior circumference of the wheel running surface.

In accordance with embodiments, the wheel running surface can include a non-magnetic material. The at least one magnet comprises a plurality of magnets distributed around the interior circumference of the wheel running surface.

According to other embodiments, the at least one magnet may be affixed to an inner or outer side of wheel in a region of the outer periphery. The at least one magnet may include a plurality of magnets distributed around the inner or outer side of the wheel in the region of the outer periphery.

In accordance with other embodiments, the at least one magnet can include a permanent magnet or an electromagnet.

Embodiments are directed to a wheel-magnet system for a transport vehicle in a transportation system, which includes a guideway along which the transport vehicle is movable and a track transported over a guideway. The wheel-magnet system includes a wheel; and at least one magnet affixed to at least one of an exterior of the wheel or an interior of the wheel. The wheel, which is spatially separated from the track in transport, is rotatably drivable by drag forces created by Eddy currents induced in the track.

According to embodiments, the wheel can further include a wheel running surface defining an outer periphery, and the at least one magnet can be affixed to an interior circumference of the wheel running surface.

In accordance with embodiments, the wheel running surface may include a non-magnetic material. The at least one magnet can include a plurality of magnets distributed around the interior circumference of the wheel running surface.

According to other embodiments, the at least one magnet can be affixed to an inner or outer side of wheel in a region of the outer periphery. The at least one magnet may include a plurality of magnets distributed around the inner or outer side of the wheel in the region of the outer periphery.

In accordance with still other embodiments, the wheel-magnet system can be a passive system configured to rotate the wheels at a speed corresponding to a transport speed of the transport vehicle along the guideway.

According to other embodiments, the transport vehicle may be guided along the guideway via magnetic coupling, and, while in transport, the wheel running surfaces of wheels can be spatially separated from the track by a distance of 50 mm or less.

Embodiments are directed to a method for performing a touchdown event for a transport vehicle moving along a guideway. Wheels of the moving transport vehicle include at least one affixed magnet and are spatially separated from tracks on which the wheels roll after the touchdown event. The method includes inducing Eddy currents in the tracks via the least one magnet affixed to the wheels, whereby drag is created to impart a rotational force on the wheels; and lowering the wheels into contact with the tracks.

According to embodiments, the at least one magnet can be affixed to at least one of an exterior of the wheel or an interior of the wheel.

In embodiments, the wheel may further include a wheel running surface defining an outer periphery, and the at least one magnet can be affixed to an interior circumference of the wheel running surface.

In other embodiments, the at least one magnet can affixed to an inner or outer side of wheel in a region of the outer periphery.

In accordance with still yet other embodiments, the wheels form a passive system to match the rotational speed of the wheels to the moving speed of the transport vehicle along the guideway.

### BRIEF DESCRIPTION OF THE DRAWINGS

These and other features of this disclosure will be best understood by reference to the following detailed description of an embodiment of the disclosure, taken in conjunction with the accompanying drawings, in which:

FIG. 1 depicts of an embodiment of a transport vehicle at rest, i.e., before starting or after stopping;

FIG. 2 depicts an embodiment of the transport vehicle in motion;

FIG. 3 depicts a side view of an embodiment of a wheel of the transport vehicle with a magnetic-field producing material to impart rotation on the wheel;

FIG. 4 depicts a side view of another embodiment of a wheel of the transport vehicle with a magnetic-field producing material to impart rotation on the wheel;

FIG. 5 depicts a front view of an embodiment of a wheel of the transport vehicle with a magnetic-field producing material affixed to an outer side surface of the wheel; and

FIG. 6 depicts a front view of another embodiment of a wheel of the transport vehicle with a magnetic-field producing material affixed within a running surface of the wheel.

### DETAILED DESCRIPTION OF THE EMBODIMENT

The novel features which are characteristic of the disclosure, both as to structure and method of operation thereof, together with further aims and advantages thereof, will be understood from the following description, considered in connection with the accompanying drawings, in which the preferred embodiment of the disclosure is illustrated by way of example. It is to be expressly understood, however, that the drawings are for the purpose of illustration and description only, and they are not intended as a definition of the limits of the disclosure.

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a magnetic material” would also mean that mixtures of one or more magnetic materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

The term “substantially parallel” refers to deviating less than 20° from parallel alignment and the term “substantially perpendicular” refers to deviating less than 20° from perpendicular alignment. The term “parallel” refers to deviating less than 5° from mathematically exact parallel alignment. Similarly “perpendicular” refers to deviating less than 5° from mathematically exact perpendicular alignment.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for example a composition comprising a compound A may include other compounds besides A. However, the term “comprising” also covers the more restrictive meanings of “consisting essentially of” and “consisting of”, so that for example “a composition comprising a compound A” may also (essentially) consist of the compound A.

The various embodiments disclosed herein can be used separately and in various combinations unless specifically stated to the contrary.

The present embodiment is related to a wheel-magnet system and method for synchronizing the rotational velocity of the wheels of a transport vehicle to a relative speed of the transport vehicle over a guideway. The wheel-magnet system may be configured such that a magnetic-field producing material is coupled to the wheel. In operation, while the transport vehicle moves along the guideway in a desired direction of travel, the wheels of the transport vehicle are not in contact with tracks located below the wheels, and when starting or stopping the transport vehicle, the wheels are in contact with the tracks. In a touchdown event, in which the wheels of a stopping transport vehicle, which are configured with embodiments of the wheel-magnet system, are moved into contact with the tracks, the wheels of the transport vehicle are rotated at a speed to match a transport speed of the transport vehicle relative to the tracks, thereby significantly reducing the acceleration component of force at touchdown and protecting the wheels from destructive damage from touchdown.

In embodiments, as the transport vehicle is being moved over the guideway, the wheels with the wheel-magnet system are not in contact with the tracks, which is a conductive surface. Moreover, the wheels of the moving transport vehicle are maintained at a distance from the tracks to ensure that drag forces are introduced between the wheel-magnet systems of the wheels and conductive surfaces of the tracks, to impart rotation on the wheels to attain velocities equal to the relative velocity between the transport vehicle and the tracks, whereby dynamic loads at the moment of touchdown are significantly lessened.

In an embodiment, a wheel-magnet system may be mounted to the chassis of the transport vehicle configured for travel over a conductive surface. The vehicle may move in a direction parallel to a conductive surface.

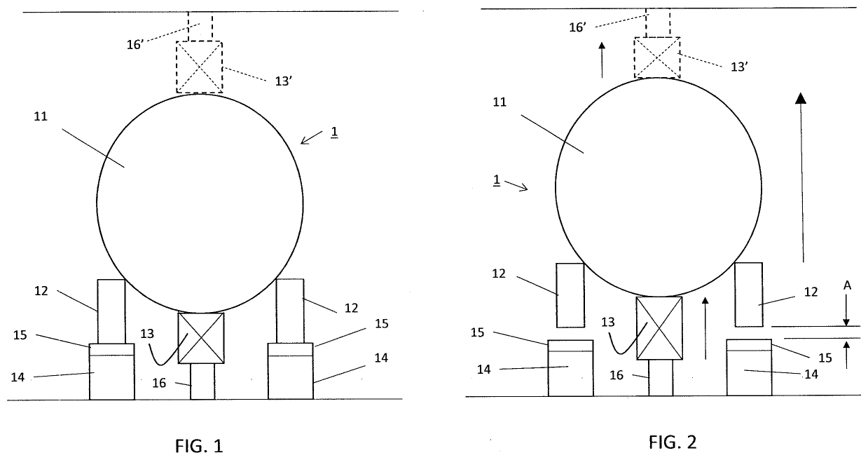

FIG. 1 illustrates an exemplary transport system in which a transport vehicle 1 is at rest, idle, and FIG. 2 illustrates the exemplary transport system of FIG. 1 in which transport vehicle 1 is in motion. With regard to FIG. 1, transport vehicle 1 can include a fuselage or pod 11 that can be supported by wheels 12. As the coupling of wheels 12 to fuselage or pod 11 can be achieved in many manners and configurations known to those ordinarily skilled in the art, the details of such coupling is not discussed further. Further, wheels 12 are arranged to support fuselage or pod 11 on tracks 15, which can be connected to a support 14 that is connected to the ground or can be connected directly to the ground (not shown).

Further, transport vehicle 1 can be configured to be transported/guided along a guideway 16, which is connected to below transport vehicle 1 and between tracks 15. Alternatively, or additionally, transport vehicle 1 can be configured to be transported/guided along a guideway 16′, which is connected to above transport vehicle 1 and between tracks 15. Tracks 15 can include at least a conductive metal surface, e.g., aluminum, steel, stainless steel. Further, the transport/guidance of transport vehicle 1 along guideway 16 and/or 16′ can be achieved via a coupling 13, 13′, e.g., magnetic coupling. Further, it is to be understood that the guideways 16, 16′ are only schematically illustrated and that guideways 16, 16′ can be configured as single or plural tracks. Further, guideways 16, 16′ can be configured as a long stator of a linear motor with at least one coil and transport vehicle 1 can be configured as a rotor of the linear motor with at least one magnet, which establishes coupling 13, 13′. Alternatively, guideways 16, 16′ can be configured with at least one magnet and transport vehicle 1 can be configured with at least one coil to establish coupling 13 Moreover, when wheels 12 are in contact with tracks 15, transport vehicle 1 is preferably maintained in a non-contacting configuration with guideways 16, 16′.

When transport vehicle 1, as shown in FIG. 2, is guided in a transport direction along the guideways 16, 16′, couplings 13, 13′ operate in a known manner lift transport vehicle 1 for magnetic levitation (maglev) transport. As a result of this lifting, a gap or separation A is produced between wheels 12 and tracks 15. In accordance with embodiments of the wheel-magnet system, while the gap or separation A is preferably less than 50 mm, gap or separation A can be any distance that allows magnetic fields of the wheel-magnet system (discussed in greater detail below) to penetrate the tracks 15, i.e., the conductive metal surface, and generate Eddy currents to create a draft force.

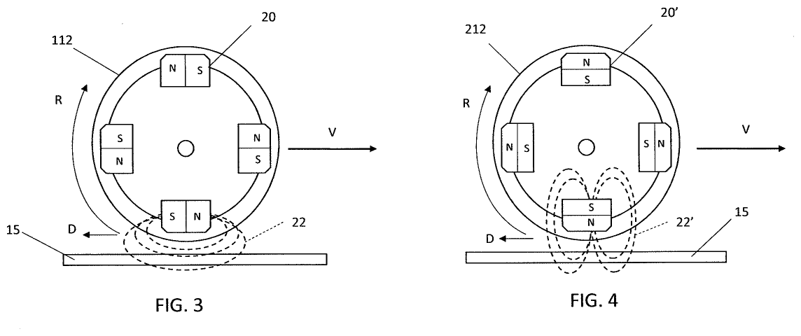

FIGS. 3 and 4 show side views of exemplary wheels 112, 212 of embodiments of wheel-magnet system 1, four magnets 20 are arranged at or near an outer periphery of wheels 112, 212. While four magnets 20 are shown in the exemplary illustrations, it is understood that more or fewer magnets 20 can be used, but at least one magnet is needed. However, as illustrated, when more than one magnet 20 is used, the magnets are preferably evenly distributed around the periphery of the wheel. It is further noted that FIG. 3 and FIG. 4 differ in the orientation of magnets 20. In FIG. 3, the N-S direction of magnet 20 closest to track 15 is parallel to track 15, while the N-S direction of magnet 20 closest to track 15 is perpendicular to track 15. These figures show that any orientation of the magnets 20 can be used (including those not illustrated, but apparent to those ordinarily skilled in the art), as long as the magnetic field 22, 22′ is sufficient to penetrate track 15, and more particularly the conductive metal surface of track 15.

As shown in FIGS. 3 and 4, direction V corresponds to a velocity and direction in which vehicle 1 is transported/guided over guideway 16, whereby wheels 112, 212 are likewise conveyed in direction V at a velocity imparted to transport vehicle 1 relative to track 15. As wheel 112, 212 is moved over track 15, magnetic fields 22, 22′ penetrating track 15 produce Eddy currents in the conductive metal surface, which creates drag D in a direction opposite direction V. Consequently, rotation R is imparted to wheels 112, 212. As magnets 20 move into a position near track 15, drag D is created, imparting further rotation R on wheels 112, 212.

Thus, embodiments of the wheel-magnet system is preferably a passive system in which wheels 112, 212 can be rotated at a same velocity as the speed of the transport vehicle without requiring any complicated control systems or driving motors. In this passive system, wheel rotation is imparted by the drag D created as magnets 20 are moved over tracks 15.

Moreover, magnets 20 are preferably permanent magnets, which can include iron, aluminum, nickel, cobalt and/or rare earth elements, such as neodymium. Alternatively, magnets 20 can be electromagnets that can be activated/deactivated in anticipation of the touchdown event.

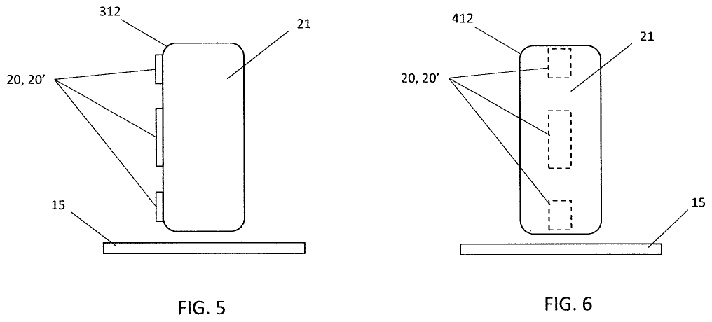

FIGS. 5 and 6 illustrate various arrangements of the magnets 20, 20′ with respect to the wheels. As shown in FIG. 5, magnets 20, 20′ can be arranged on or attached to an exterior of wheel 312. These magnets can be arranged on the inner and/or outer sides of the wheels, and can advantageously be retrofitted onto existing wheels. When magnets are arranged on both the inner and outer sides of the wheels, the magnets on one side of the wheel can be arranged opposite the magnets on the other side of the wheel or the magnets on one side of the wheel can be angularly offset from the magnets on the other side of the wheel.

In FIG. 6, magnets 20, 20′ can be arranged on or attached to an interior of a wheel running surface of wheel 412. In accordance with this embodiment, the wheel running surface of wheel 412 is formed of a magnetically permeable material, and can preferably be a non-magnetic metal such as aluminum.

In other embodiments (not shown), magnets 20, 20′ can be arranged on or along an exterior of the wheel and arranged on an interior of the wheel running surface. Moreover, the magnets arranged on both the exterior and interior surfaces of the wheels can be arranged adjacent each other or can be angularly offset from each other. Moreover, it is understood that other arrangements of the magnets in and/or on the wheel can be utilized without departing from the spirit and scope of the embodiments described herein provided that the magnetic fields of the magnets are positionable to generate Eddy currents in the conductive surface of the tracks.

In accordance with aspects of the disclosure, the at least one magnet 20, 20′ is placed to ensure that rotation of the wheel is equivalent to the lateral speed of the transport vehicle. Moreover, the at least one magnet 20, 20′ preferably exhibits a strong enough magnetic field to constantly induce Eddy currents in the conductive surface of the tracks, although the field does not need to be a continuous one across the wheel.

In a further embodiment, a wheel (not shown) may be composed of a material that exhibits characteristics of a permanent magnet. The wheel may exhibit its own magnetic field as it moves parallel to a conductive surface, generating eddy currents. The eddy currents create drag, causing rotation of the wheel, matching the velocity of a conductive surface moving below.

While the specification describes particular embodiments of the present disclosure, those of ordinary skill can devise variations of the present disclosure without departing from the inventive concept.

Insofar as the description above and the accompanying drawing disclose any additional subject matter that is not within the scope of the single claim below, the disclosures are not dedicated to the public and the right to file one or more applications to claim such additional disclosures is reserved.

We claim:

1. A wheel for a transport vehicle movable along a guideway in a transportation system, wherein the transportation system comprises a conductive surface arranged substantially parallel to the guideway, the wheel comprising:
at least one magnet affixed to at least one of an exterior of the wheel or an interior of the wheel,
wherein the wheel is rotatably drivable by drag forces created in the conductive surface, which is spatially separate from the wheel in transport.

2. The wheel according to claim 1, further comprising a wheel running surface defining an outer periphery,
wherein the at least one magnet is affixed to an interior circumference of the wheel running surface.

3. The wheel according to claim 2, wherein the wheel running surface comprises a non-magnetic material.

4. The wheel according to claim 3, wherein the at least one magnet comprises a plurality of magnets distributed around the interior circumference of the wheel running surface.

5. The wheel according to claim 2, wherein the at least one magnet is affixed to an inner or outer side of wheel in a region of the outer periphery.

6. The wheel according to claim 5, wherein the at least one magnet comprises a plurality of magnets distributed around the inner or outer side of the wheel in the region of the outer periphery.

7. The wheel according to claim 1, wherein the at least one magnet comprises a permanent magnet or an electromagnet.

8. A wheel-magnet system for a transport vehicle in a transportation system, the transportation system including a guideway along which the transport vehicle is movable and a track transported over a guideway, the wheel-magnet system comprising:
a wheel;
at least one magnet affixed to at least one of an exterior of the wheel or an interior of the wheel,
wherein the wheel, which is spatially separated from the track in transport, is rotatably drivable by drag forces created by Eddy currents induced in the track.

9. The wheel-magnet system according to claim 8, wherein the wheel further comprises a wheel running surface defining an outer periphery,
wherein the at least one magnet is affixed to an interior circumference of the wheel running surface.

10. The wheel-magnet system according to claim 9, wherein the wheel running surface comprises a non-magnetic material.

11. The wheel-magnet system according to claim 10, wherein the at least one magnet comprises a plurality of magnets distributed around the interior circumference of the wheel running surface.

12. The wheel-magnet system according to claim 9, wherein the at least one magnet is affixed to an inner or outer side of wheel in a region of the outer periphery.

13. The wheel-magnet system according to claim 12, wherein the at least one magnet comprises a plurality of magnets distributed around the inner or outer side of the wheel in the region of the outer periphery.

14. The wheel-magnet system according to claim 8, which is a passive system configured to rotate the wheels at a speed corresponding to a transport speed of the transport vehicle along the guideway.

15. The wheel-magnet system according to claim 8, wherein the transport vehicle is guided along the guideway via magnetic coupling, and, while in transport, the wheel running surfaces of wheels are spatially separated from the track by a distance of 50 mm or less.

16. A method for performing a touchdown event for a transport vehicle moving along a guideway, wherein wheels of the moving transport vehicle include at least one affixed magnet and are spatially separated from tracks on which the wheels roll after the touchdown event, the method comprising:
inducing Eddy currents in the tracks via the least one magnet affixed to the wheels, whereby drag is created to impart a rotational force on the wheels; and
lowering the wheels into contact with the tracks.

17. The method according to claim 16, wherein the at least one magnet is affixed to at least one of an exterior of the wheel or an interior of the wheel.

18. The method according to claim 17, wherein the wheel further comprises a wheel running surface defining an outer periphery, and the at least one magnet is affixed to an interior circumference of the wheel running surface.

19. The method according to claim 17, wherein the at least one magnet is affixed to an inner or outer side of wheel in a region of the outer periphery.

20. The method according to claim 17, wherein the wheels form a passive system to match the rotational speed of the wheels to the moving speed of the transport vehicle along the guideway.
